(19) United States
(12) Patent Application Publication
(10) Pub. No.: US 2002/0140681 A1
(43) Pub. Date: Oct. 3, 2002

(54) Mobile information terminal apparatus

(75) Inventor: Hirotoshi Ichikawa, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OLYMPUS OPTICAL CO., LTD., Tokyo (JP)

(21) Appl. No.: 10/084,538

(22) Filed: Feb. 26, 2002

(30) Foreign Application Priority Data
Feb. 28, 2001 (JP) 2001-055610

(51) Int. Cl. G09G 5/00

(52) U.S. Cl. 345/169

(57) ABSTRACT

A mobile information terminal apparatus includes a first body, a second body, and an image display section having an image display device, a magnifying optical part which magnifies the image displayed by the image display device, and an observation window which is provided on a surface of the first body and leads the image magnified by the magnifying optical part to the outside. The second body pivots between a closed position in which it partially covers the surface of the first body and an opened position in which it angles to the first body. The apparatus includes an operation section provided on the first body, a display section provided on the second body, and pointing device to operate the image displayed by the image display device. The pointing device and observation window are disposed to face toward the outside when the second body is in the closed position.

### CROSS-REFERENCE TO RELATED APPLICATIONS

This application is based upon and claims the benefit of priority from the prior Japanese Patent Application No. 2001-55610, filed Feb. 28, 2001, the entire contents of which are incorporated herein by reference.

### BACKGROUND OF THE INVENTION

The present invention relates to a mobile information terminal apparatus in which a display section having a magnifying optical system and being capable of displaying very fine data is built or detachably supported.

In recent years, there has been increased a demand for reading, for example, information on the Internet with use of a mobile information terminal apparatus. Accordingly, a display device which is mounted in the mobile information terminal apparatus has been made in color and in high resolution. In the situation described above, there has been proposed an apparatus in which a display image is observed with use of a small-sized display device such as QVGA, VGA, etc. and a magnifying optical system. The small-sized display device is capable of displaying in high resolution and sized in one inch or less.

Hereinafter, the prior art will be described with reference to FIGS. 6 to 9. In the Jpn. Pat. Appln. KOKAI Publication No. 5-259964, disclosed is a mobile type communication receiver which has a small-sized virtual image display 601 providing a magnified virtual image, as shown in FIG. 6. In the invention disclosed therein, the small-sized virtual image display 601 is separated from a body 602.

With respect to an external display apparatus which is separated from a body in the manner described above and provides a finer screen than one through a display section mounted in the body, a mobile type telephone set using a liquid crystal display of about two inches, through which a user observes the display screen as it is, is on the market.

In the Jpn. Pat. Appln. KOKAI Publication No. 10-123969, disclosed is a mobile power supply which functions as an accessory of a mobile electronic apparatus and includes a minute visual image display 701 as shown in FIG. 7. This mobile power supply can be connected to a mobile type telephone set 702. The mobile power supply is constructed by pivotably mounting a display 701 in a housing 703 having a power supply.

In the Jpn. Pat. Appln. KOKAI Publication No. 2-100448, a mobile type telephone set, in which a virtual image visual display means 802 is included in a L-shaped body 801 as shown in FIG. 8, is disclosed.

In the Jpn. Pat. Appln. KOKAI Publication No. 11-327462, disclosed is a mobile type telephone set in which a display section which magnifies a virtual image is constructed in a collapsible manner, as shown in FIG. 9.

However, the conventional telephone sets such as ones described above have the following problems. In general, a telephone set with a viewer, to which a virtual image is projected, is used in a manner that a user looks into a display. The reason is that, as it is intended to enlarge an eye point, the optical system becomes also large, thus mobility of the telephone set deteriorates. On the other hand, a menu operation etc. in browser software is required for reading contents, thus a pointing device is used for this operation. Therefore, a user must observe the screen while operating the pointing device in the state of closing up his or her face to the telephone set, accordingly, operatability of the telephone set shown in FIGS. 7, 8 and 9 is not good. Particularly, when a telephone set is miniaturized, operatability further deteriorates in the case where its operation buttons are close to one another.

In a separate type of mobile communication receiver shown in FIG. 6, some operatability is secured by providing a pointing device on the body 602, however, the display 601 must be carried separately from the body 602. Thus mobility is not good at all.

In the conventional telephone sets described above, and a magnifying optical system is incorporated into the apparatus, a high resolution image can be observed. At the same time, a problem occurs in that the apparatus becomes thicker, particularly in a thickness direction compared with the case of using a normal LCD.

In addition, as described above, the telephone set needs to be close to a user's face in order to observe an image by the magnifying optical system. Therefore, usage of the telephone set is very different from the conventional one. Furthermore, a high resolution display is not necessary for simply confirming a dial, selecting and setting functions of the body from the beginning. That is, there are two demands; one is to observe a high resolution screen, and the other is to easily use the apparatus with simple operations. Therefore, a telephone set, which can satisfy both the above demands and is convenient to use, has been desired.

### BRIEF SUMMARY OF THE INVENTION

A mobile information terminal apparatus according to an aspect of the invention, comprises: a first body; a second body pivotably supported on the first body; and an image display section having an image display device which displays an image, a magnifying optical part which magnifies the image displayed by the image display device, and an observation window which is provided on a surface of the first body and leads the image magnified by the magnifying optical part to the outside. The second body pivots in a range between a closed position in which the second body partially covers the surface of the first body and an opened position in which the second body has an angle to the first body. The mobile information terminal apparatus comprises: an operation section provided on the first body; a display section which is provided on the second body and has lower resolution than one of the image display device; and at least one pointing device to operate at least the image displayed by the image display device. The at least one pointing device and the observation window of the image display section are disposed so as to face toward the outside when the second body is in the closed position.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1A is a perspective view of a mobile information terminal apparatus according to a first embodiment of the present invention in the case of an opened position;

FIG. 1B is a perspective view of the mobile information terminal apparatus shown in FIG. 1A in the case of a closed position;

FIG. 1C is a cross-sectional view taken along a 1C-1C line shown in FIG. 1A;

FIG. 2A is a perspective view of a mobile information terminal apparatus according to a second embodiment of the invention in the case of an opened position;

FIG. 2B is a perspective view of the mobile information terminal apparatus shown in FIG. 2A in the case of a closed position;

FIG. 3A is a perspective view of a mobile information terminal apparatus according to a third embodiment of the invention in the case of an opened position;

FIG. 3B is a perspective view of the mobile information terminal apparatus shown in FIG. 3A in the case of a closed position;

FIG. 3C is a cross-sectional view taken along a 3C-3C line shown in FIG. 3A;

FIG. 4A is a perspective view of a mobile information terminal apparatus according to a fourth embodiment of the invention in the case of an opened position;

FIG. 4B is a perspective view of the mobile information terminal apparatus shown in FIG. 4A in the case of a closed position;

FIG. 5 is a perspective view of a mobile information terminal apparatus according to a fifth embodiment of the invention in the case of an opened position;

FIG. 6 is a perspective view of a conventional mobile type communication receiver;

FIG. 7 is a conventional mobile power supply to which a mobile type telephone set can be connected;

FIG. 8 is a perspective view showing a state where a conventional mobile type telephone set is equipped to a user's head; and

FIG. 9 is a perspective view of another conventional mobile type telephone set.

### DETAILED DESCRIPTION OF THE INVENTION

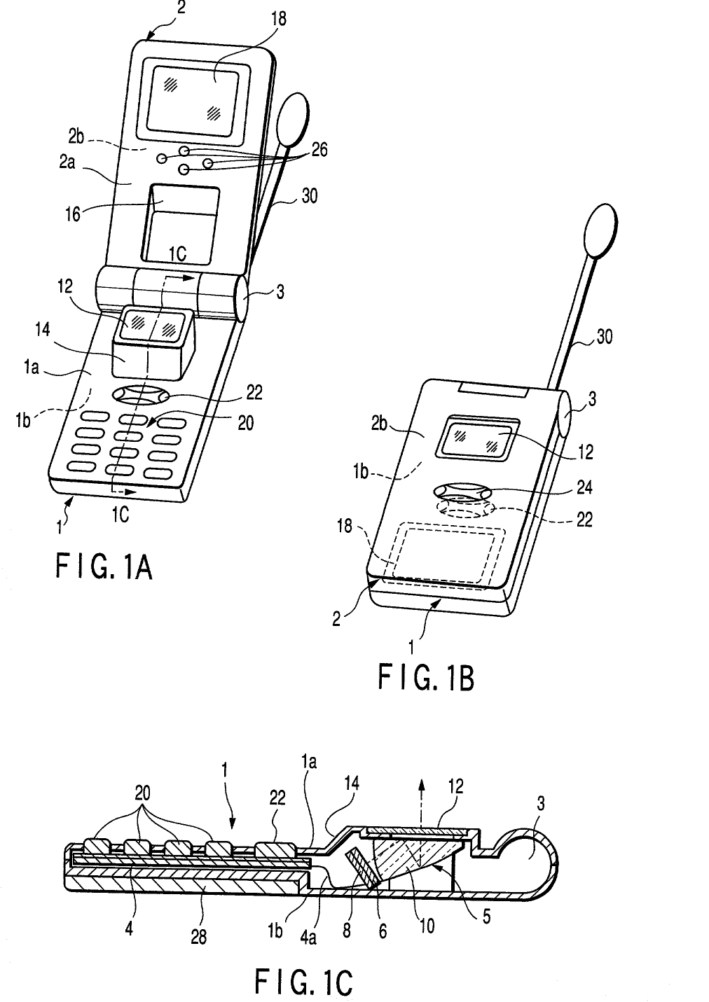

A mobile information terminal apparatus according to embodiments of the present invention now will be described with reference to FIGS. 1A to 5. First of all, a mobile information terminal apparatus according to a first embodiment will be described with reference to FIGS. 1A to 1C.

This mobile information terminal apparatus is used as a mobile telephone set. The mobile information terminal apparatus comprises a first body 1 and a second body 2 pivotably supported on the first body 1. The first body 1 and second body 2 are connected to each other through a pivot part 3. The second body 2 pivots in a range between a closed position (see FIG. 1B) which the second body 2 covers a part of a surface of the first body 1, i.e. a front surface 1a and an opened position (see FIG. 1A) which the second body 2 has an angle to the first body 1.

A substrate 4 with an electronic circuit formed thereon and an image display section 5 for projecting an image are built in the first body 1. The image display section 5 has a LCD 6 used as an image display device to display an image, a back light 8 provided on the LCD 6, a magnifying optical part 10 having a magnifying optical system which magnifies the image displayed by the LCD 6, and an observation window 12 which is provided on the front surface 1a of the first body 1 and leads the image magnified by the magnifying optical part 10 to the outside. Light including the image displayed by the LCD 6 is propagated in the magnifying optical part 10 along a dot-and-dash line shown in FIG. 1C, and led to the outside from the observation window 12. The LCD 6 and back light 8 are connected to the substrate 4 through an appropriate wiring 4a. The image display section 5 is capable of magnifying a virtual image of an extremely fine image such as QVGA, VGA, etc., thereby projecting the virtual image to user's eyes.

The magnifying optical part 10 preferably has a free shaped surface optical device, or more preferably a free shaped surface prism. With use of the magnifying optical part 10 of this kind, the magnifying optical part 10 can be formed relatively thin, and has an advantage in correcting an aberration. In addition, with use of the magnifying optical part 10, a magnifying rate can be relatively higher so that a user can appreciate an image of higher resolution.

An observation projection 14 which projects from the front surface la is formed in a part in which the image display section 5 is built on the front surface 1a. With this projection, the magnifying optical part 10 that is relatively thicker than the other members such as the substrate 4 etc. is covered by the observation projection 14 and thus built in the first body 1. The observation window 12 is mounted in the observation projection 14 to face toward the outside.

The second body 2 has a front surface 2a opposing the first body 1 in the closed position described above and a back surface 2b located on the side opposite the front surface 2a. An opening 16 which goes through the second body 2 from the front surface 2a to the back surface 2b is formed in a part of the second body 2 which opposes the observation projection 14 of the first body 1 in the case of the closed position. With this opening, the observation window 12 faces toward the outside without being influenced by whether the second body 2 is in the opening position or closed position. Thus, the user can observe the observation window 12 in cases of both positions. In addition, the observation projection 14 is stored in the opening 16 in the case of the closed position. Therefore, a projecting part is not formed when the mobile information terminal apparatus is carried in a collapsed manner. Thus, a relatively thinner mobile information terminal apparatus can be realized.

A display section 18 having a relatively lower resolution than one of the LCD 6 is provided on the front surface 2a of the second body 2. The display section 18 has a display area having a resolution the same as a liquid crystal display which is provided in the conventional mobile information terminal apparatus and does not use the magnifying optical system.

On the front surface 1a of the first body 1, an operation section 20 is provided. The operation section 20 has a plurality of push-buttons, which are used for a normal calling operation or function setting of the mobile information terminal apparatus.

On the front surface la and back surface 2b, a main operation member 22 and subordinate operation member 24 are provided, respectively. The main operation member 22 has a crosshair button, which is used to operate at least an image displayed by the LCD 6. The main operation member 22 is used for instructing a menu of a browser, or the like. The subordinate operation member 24 is disposed in a part opposing the main operation member 22 in the case of the closed position, and consists of a crosshair button.

At a part of the second body 2 between the main operation member 22 and subordinate operation member 24 in the case of the closed position, a connecting member 26 which consists of four pins and extends from the subordinate operation member 24 to the front surface 2a is disposed. In the case of the closed position, the connecting member 26 connects the main operation member 22 and subordinate operation member 24. This connection interlocks the main operation member 22 with subordinate operation member 24. The main operation member 22, subordinate operation member 24 and connecting member 26 constitute a pointing device.

A battery 28 is mounted on the back surface 1b on the opposite side of the front surface 1a in the first body 1. The mobile information terminal apparatus has an antenna 30.

In the first embodiment of the mobile information terminal apparatus described in detail above, intending to use the mobile information terminal apparatus simply as a communication apparatus, a user can achieve his or her object by using the apparatus in the same manner as the conventional mobile information terminal apparatus while confirming operations through the LCD 6. On the other hand, when an extremely fine display such as displaying the Internet is required, the user turns mobile information terminal apparatus into the state of the closed position so as to collapse the apparatus, and looks into the observable observation window 12 from the back surface 2b. As a result, the user can observe the desiring image. A menu operation at this time is performed through the subordinate operation member 24 of the pointing device. Since no other unnecessary buttons or the like exist around the subordinate operation member 24, a reliable operation can be performed without paying attention every time to the hand that is used for operation. Furthermore, the subordinate operation member 24 may be located in a position sufficiently apart from the observation window 12 so as to improve operability.

In the embodiment, the pointing device has the main operation member 22 and subordinate operation member 24, the both connected through the connecting member 26 to each other. However, the invention is no limited to this construction. For example, the subordinate operation member 24 may be electronically interlocked with the main operation member 22 without using the connecting member 26. In this case, the operation parts 22 and 24 function as pointing devices individually. In addition, the main operation member 22 and subordinate operation member 24 are not limited to consist of a crosshair button like member, but may include another member.

Furthermore, in the embodiment the image display section 5 is built in the first body 1. However, the image display section 5 may be detachably supported in the first body 1.

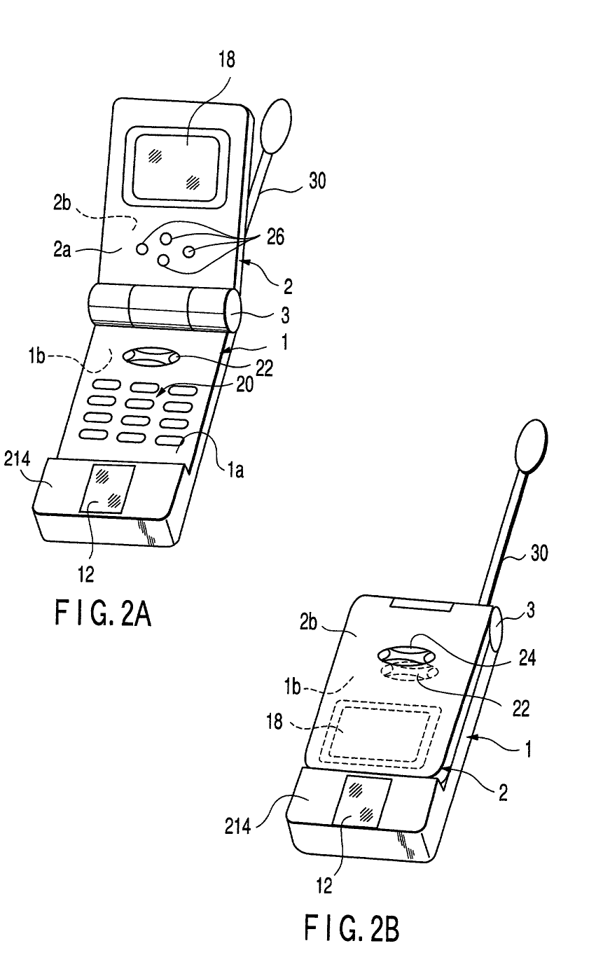

Next, a mobile information terminal apparatus according to a second embodiment of the invention will be described with reference to FIGS. 2A and 2B. Most construction according to the second embodiment is basically the same as the first embodiment. Note that, in the second embodiment, the same constituting members as those described with reference to FIGS. 1A, 1B and 1C in the first embodiment are indicated by the same reference numerals and the detailed descriptions will be omitted.

The difference in construction of the second embodiment from one of the first embodiment is in the construction of the observation projection which covers the magnifying optical part. The observation projection 14 according to the first embodiment is formed at the position opposing the front surface 2a of the second body 2 in the case of the closed position as described above, and stored in the opening 16.

On the other hand, an observation projection 214 according to the second embodiment is formed in the part of the front surface 1a in which is located on the side opposite the pivot part 3 and not covered with the second body 2 in the case of the closed position. The observation window 12 is mounted in the observation projection 214, and faces toward the outside.

With this construction too, the user can still observe the observation window 12 in the same manner as that in the first embodiment, without being influenced by the position of the second body 2, i.e., whether the second body 2 is in the opened position or closed position.

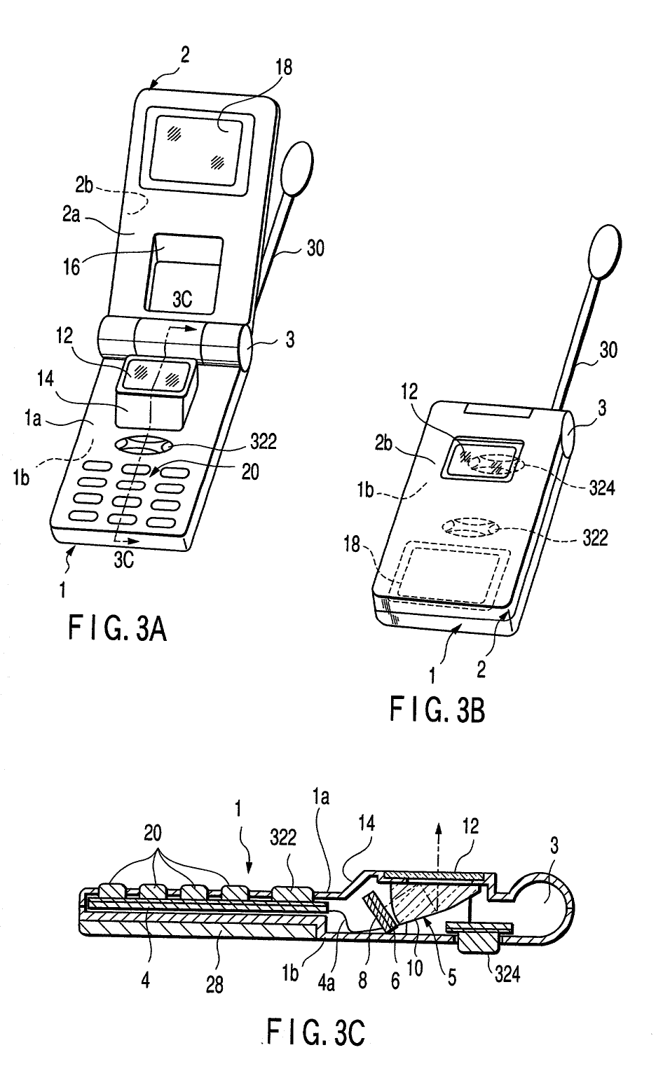

Next, a mobile information terminal apparatus according to a third embodiment of the invention will be described with reference to FIGS. 3A, 3B and 3C. Most construction according to the third embodiment is basically the same as the first embodiment. Note that, in the third embodiment, the same constituting members as those described with reference to FIGS. 1A, 1B and 1C in the first embodiment are indicated by the same reference numerals and the detailed descriptions will be omitted.

The difference in construction of the third embodiment from the first embodiment is in the construction of the subordinate operation member of the pointing device. In the first embodiment, the subordinate operation member 24 is connected to the main operation members 22 through the connecting member 26 and is interlocked with the main operation members 22. The subordinate operation member 24 is disposed on the back surface 2b of the second body 2.

On the other hand, in the third embodiment, no connecting member is used and two individual pointing devices 322 and 324 are disposed individually instead of the operation parts 22 and 24 in the first embodiment. The pointing devices 322 and 324 are electronically interlocked with each other. The pointing device 324 is disposed on the back surface 1b of the first body 1.

With this construction too, the user can carry out a reliable operation while looking into the observation window 12 without paying attention to the hand that is used for operation.

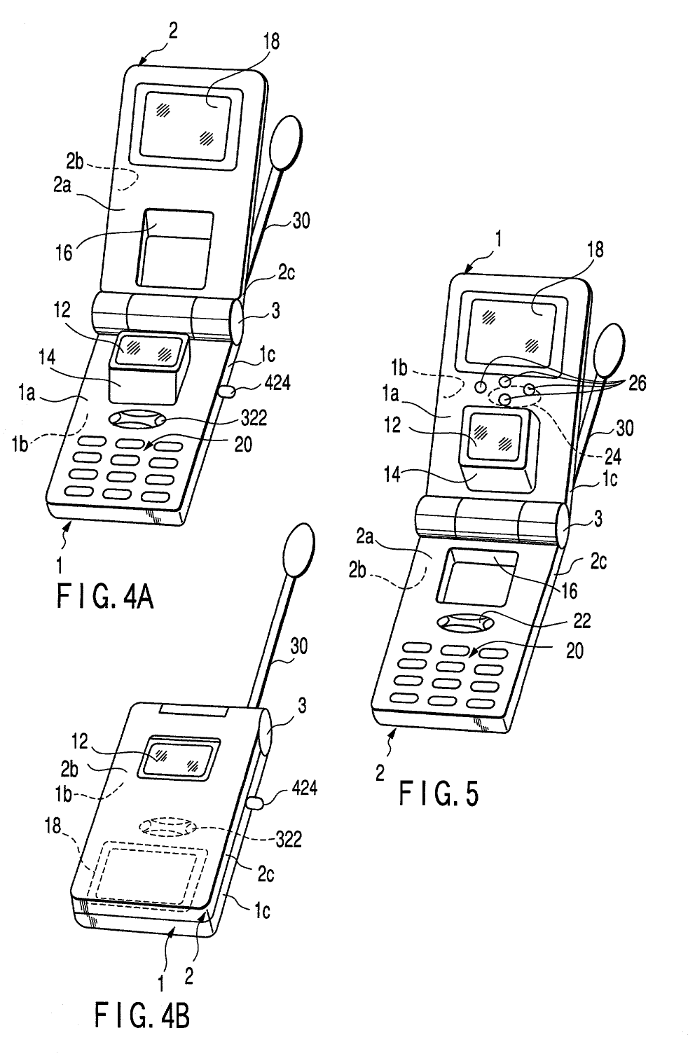

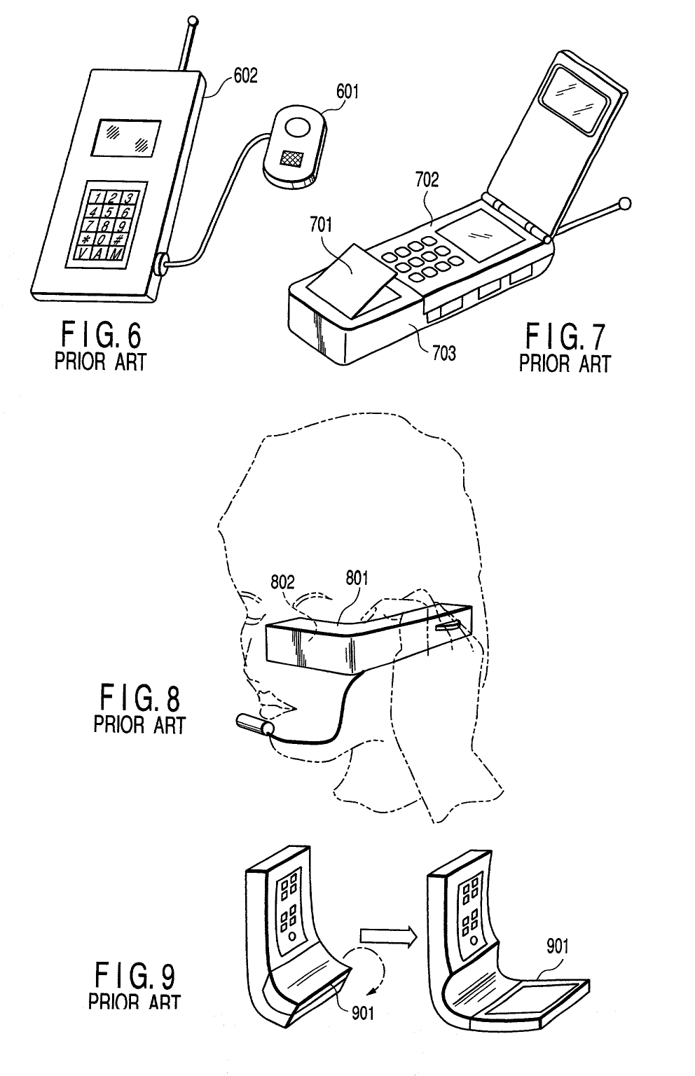

Next, a mobile information terminal apparatus according to a fourth embodiment of the invention will be described with reference to FIGS. 4A and 4B. Most construction according to the fourth embodiment is basically the same as the third embodiment. Note that, in the fourth embodiment, the same constituting members as those described with reference to FIGS. 3A, 3B and 3C in the third embodiment are indicated by the same reference numerals and the detailed descriptions will be omitted.

The difference in construction of the fourth embodiment from the third embodiment is in the construction of the pointing device. In the third embodiment, the pointing device 324 is disposed on the back surface 1b of the first body 1 and consists of the crosshair button.

On the other hand, in the fourth embodiment, a pin like pointing device 424 is disposed on the side surface 1c in the first body 1 extending between the front surface la and back surface 1b, instead of the pointing device 324 in the third embodiment. The pointing device 424 can pivot in two directions.

With this construction too, the user can carry out a reliable operation while looking into the observation window 12.

In the fourth embodiment, the pointing device 424 is disposed on the side surface 1c. However, the device 424 may be disposed on the side surface 2c in the second body 2 extending between the front surface 2a and back surface 2b.

In addition, the pointing device 424 is not limited to the pin like member but may consist of another member.

Next, a mobile information terminal apparatus according to a fifth embodiment of the invention will be described with reference to FIG. 5. Most construction according to the fifth embodiment is basically the same as the first embodiment. Note that, in the fifth embodiment, the same constituting members as those described with reference to FIGS. 1A, 1B and 1C in the first embodiment are indicated by the same reference numerals and the detailed descriptions will be omitted.

The difference in construction of the fifth embodiment from the first embodiment is in the layout of the respective constituting members. In the fifth embodiment, the first body 1 is provided with the image display section 5, the observation window 12, the observing projection 14, the display section 18, the subordinate operating part 24 disposed on the back surface 1b and the connecting member 26, and the second body 2 is provided with the opening 16, the operation section 20 and the main operation members 22.

With this construction too, the user can carry out a reliable operation while looking into the observation window 12 without paying attention to the hand that is used for operation.

In the fifth embodiment, the pointing device has the main operation members 22, the subordinate operating part 24 disposed on the back surface 1b and the connecting member 26. However, the construction of the pointing device is not limited to the one described above. For example, two individual pointing devices may be provided, one disposed on the front surface 2a of the second body 2, and the other disposed on the back surface 2b of the second body 2. Alternatively, one of the pointing devices may be disposed on the front surface 2a of the second body 2 and the other one disposed on the side surface 1c of the first body 1, or on the side surface 2c of the second body 2.

Each of the mobile information terminal apparatuses according to the first to fifth embodiments described above are used as a mobile telephone set. However, the usage of those apparatuses is not limited to the above cases. For example, the apparatuses may be used as a mobile type of TV, PDA (Personal Digital Assistance) or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile information terminal apparatus comprising:
a first body;
a second body pivotably supported on the first body; and
an image display section having an image display device which displays an image, a magnifying optical part which magnifies the image displayed by the image display device, and an observation window which is provided on a surface of the first body and leads the image magnified by the magnifying optical part to the outside, the second body pivoting in a range between a closed position in which the second body partially covers the surface of the first body and an opened position in which the second body has an angle to the first body, wherein the mobile information terminal apparatus comprises:
an operation section provided on the first body;
a display section which is provided on the second body and has lower resolution than one of the image display device; and
at least one pointing device to operate at least the image displayed by the image display device, the at least one pointing device and the observation window of the image display section being disposed so as to face toward the outside when the second body is in the closed position.

2. The apparatus according to claim 1, wherein the image display section is built in at least one of the first body and the second body.

3. The apparatus according to claim 1, wherein the image display section is detachably supported in at least one of the first body and the second body.

4. The apparatus according to claim 1, wherein the first body has a front surface which is included in the surface of the first body and covered by the second body when the second body is in the closed position and a back surface located on the side opposite the front surface, and the pointing device is disposed on the back surface of the first body.

5. The apparatus according to claim 1, wherein the second body has a front surface which opposes the first body when the second body is in the closed position and a back surface located on the side opposite the front surface, and the pointing device is disposed on the back surface of the second body.

6. The apparatus according to claim 1, wherein the second body has:
a front surface which opposes the first body when the second body is in the closed position; and
a back surface located on the side opposite the front surface, and
the pointing device has:
a main operation member to operate at least an image which is displayed by the image display device;
a subordinate operation member disposed on the back surface of the second body; and
a connecting member which connects the subordinate operation member and the main operation member to each other, and the main operation member and the subordinate operation member are interlocked with each other.

7. The apparatus according to claim 1, wherein the first body has: a front surface which is included in the surface of the first body and covered by the second body when the second body is in the closed position; a back surface located on the side opposite the front surface; and a side surface extending between the back surface and the front surface,
the second body has: a front surface which opposes the first body when the second body is in the closed position; a back surface located on the side opposite the front surface; and a side surface extending between the back surface and the front surface, and
the pointing device is disposed on the side surface of the first body or on the side surface of the second body.

8. The apparatus according to claim 1, wherein the first body has a front surface which is included in the surface of the first body and covered by the second body when the second body is in the closed position,
the second body has a front surface opposite to the first body when the second body is in the closed position, and a back surface located on the side opposite the front surface,
the observation window is provided on the front surface of the first body,
an opening which goes through the second body from the front surface to the back surface is provided in a part of the second body which opposes the observation window when the second body is in the closed position, and
the observation window faces toward the outside from the opening when the second body is in the closed position.

9. The apparatus according to claim 1, wherein the magnifying optical part has a free shaped surface optical device.

10. The apparatus according to claim 1, wherein the magnifying optical part has a free shaped surface prism.

11. A mobile information terminal apparatus comprising:
a first body;
a second body pivotably supported on the first body; and
an image display section having an image display device which displays an image, a magnifying optical part which magnifies the image displayed by the image display device, and an observation window which is provided on a surface of the first body and leads the image magnified by the magnifying optical part to the outside, the second body pivoting in a range between a closed position in which the second body partially covers the surface of the first body and an opened position in which the second body has an angle to the first body, wherein the mobile information terminal apparatus comprises:
an operation section provided on the second body;
a display section which is provided on the first body and has lower resolution than one of the image display device; and
at least one pointing device to operate at least the image displayed by the image display device, the at least one pointing device and the observation window of the image display section being disposed so as to face toward the outside when the second body is in the closed position.

12. The apparatus according to claim 11, wherein the image display section is built in at least one of the first body and the second body.

13. The apparatus according to claim 11, wherein the image display section is detachably supported in at least one of the first body and the second body.

14. The apparatus according to claim 11, wherein the first body has a front surface which is included in the surface of the first body and covered by the second body when the second body is in the closed position and a back surface located on the side opposite the front surface, and the pointing device is disposed on the back surface of the first body.

15. The apparatus according to claim 11, wherein the second body has a front surface which opposes the first body when the second body is in the closed position and a back surface located on the side opposite the front surface, and the pointing device is disposed on the back surface of the second body.

16. The apparatus according to claim 11, wherein the first body has:
a front surface which is included in the surface of the first body and covered by the second body when the second body is in the closed position; and
a back surface located on the side opposite the front surface, and
the pointing device has:
a main operation member to operate at least an image which is displayed by the image display device;
a subordinate operation member disposed on the back surface of the first body; and
a connecting member which connects the subordinate operation member and the main operation member to each other, and the main operation member and the subordinate operation member are interlocked with each other.

17. The apparatus according to claim 11, wherein the first body has: a front surface which is included in the surface of the first body and covered by the second body when the second body is in the closed position; a back surface located on the side opposite the front surface; and a side surface extending between the back surface and the front surface,
the second body has: a front surface which opposes the first body when the second body is in the closed position; a back surface located on the side opposite the front surface; and a side surface extending between the back surface and the front surface, and
the pointing device is disposed on the side surface of the first body or on the side surface of the second body.

18. The apparatus according to claim 11, wherein the first body has a front surface which is covered by the second body when the second body is in the closed position,
the second body has a front surface opposite to the first body when the second body is in the closed position, and a back surface located on the side opposite the front surface,
the observation window is provided on the front surface of the first body,
an opening which goes through the second body from the front surface to the back surface is provided in a part of the second body which opposes the observation window when the second body is in the closed position, and
the observation window faces toward the outside from the opening when the second body is in the closed position.

19. The apparatus according to claim 11, wherein the magnifying optical part has a free shaped surface optical device.

20. The apparatus according to claim 11, wherein the magnifying optical part has a free shaped surface prism.
